(19) United States
(12) Patent Application Publication
(10) Pub. No.: US 2011/0157523 A1
(43) Pub. Date: Jun. 30, 2011

(54) LIQUID CRYSTAL DISPLAY DEVICE

(76) Inventors: Jun-Hee Lee, Seoul (KR); Hyeon-Ho Son, Goyang-si (KR)

(21) Appl. No.: 12/977,423

(22) Filed: Dec. 23, 2010

(30) Foreign Application Priority Data
Dec. 28, 2009 (KR) 10-2009-0132241

(51) Int. Cl. G02F 1/1335

(52) U.S. Cl. 349/96

(57) ABSTRACT

A liquid crystal display device includes: upper and lower substrates facing and spaced apart from each other; a liquid crystal layer between the upper and lower substrates; an upper polarizing plate on an outer surface of the upper substrate; and a lower polarizing plate on an outer surface of the lower substrate, wherein one of the upper and lower polarizing plates includes a first polarizing layer having a first optical axis and a first absorption axis perpendicular to each other, and an other of the upper and lower polarizing plates includes a second polarizing layer having a second optical axis and a second absorption axis parallel to each other.

This application claims the benefit of Korean Patent Application No. 10-2009-0132241, filed on Dec. 28, 2009, which is hereby incorporated by reference in its entirety.

### BACKGROUND OF THE INVENTION

1. Field of the Invention

The present invention relates to a liquid crystal display (LCD) device, and more particularly, to an in-plane switching (IPS) mode LCD device where a viewing angle property is improved due to a polarizing film.

2. Discussion of the Related Art

In general, the LCD device uses the optical anisotropy and polarization properties of liquid crystal molecules to produce an image. Since the liquid crystal molecules have long thin shapes, the liquid crystal molecules are aligned along a specific direction. The alignment direction of the liquid crystal molecules can be controlled by applying an electric field. Accordingly, the alignment of the liquid crystal molecules changes in accordance with the direction of the applied electric field and the light is refracted along the alignment direction of the liquid crystal molecules due to the optical anisotropy, thereby images displayed.

The LCD device has various display modes according to the alignment of the liquid crystal molecules. Among various display modes for the LCD device, a twisted nematic (TN) mode having an advantage in displaying black and white, a fast response speed and a low driving voltage is widely used. In a TN mode LCD device, the liquid crystal molecules are arranged to be parallel to two substrates, and the liquid crystal molecules are aligned to be perpendicular to the two substrates when a voltage is applied. Accordingly, the TN mode LCD device has a disadvantage of a narrow viewing angle due to the refractive index anisotropy of the liquid crystal molecules when the voltage is applied. In order to improve the viewing angle, an in-plane switching (IPS) mode LCD device having a wide viewing angle property has been suggested.

FIG. 1 is a cross-sectional view showing an IPS mode LCD device according to the related art. In FIG. 1, an IPS mode LCD device 10 includes upper and lower substrates 12 and 14 facing and spaced apart from each other, a liquid crystal layer 16 between the upper and lower substrates 12 and 14, and upper and lower polarizing plates 18a and 18b on outer surfaces of the upper and lower substrates 12 and 14, respectively.

The upper polarizing plate 18a includes a first inner supporting layer 24a on the outer surface of the upper substrate 12, an upper polarizing layer 20a on the first inner supporting layer 24a and a first outer supporting layer 22a on the upper polarizing layer 20a. The lower polarizing plate 18b includes a second inner supporting layer 24b attached to the outer surface of the lower substrate 14, an lower polarizing layer 20b on the second inner supporting layer 24b and a second outer supporting layer 22b on the lower polarizing layer 20b. Each of the upper and lower polarizing layers 20a and 20b has an O-type polarizer, and polarization axes of the upper and lower polarizing layers 20a and 20b are perpendicular to each other. The first inner and outer supporting layers 22a and 24a and the second inner and outer supporting layers 22b and 24b are used for protecting the upper and lower polarizing layers 20a and 20b and may have a film type.

In the IPS mode LCD device 10, a pair of electrodes parallel to the upper and lower substrates 12 and 14 are formed in a pixel region and liquid crystal molecules are aligned in a plane along a horizontal electric field between the pair of electrodes. Since the liquid crystal molecules rotate in the plane along the horizontal electric field, the gray inversion due to the refractive index anisotropy of the liquid crystal molecules is prevented and a viewing angle property along up, down, right and left directions is improved. However, a viewing angle property along a diagonal direction is deteriorated due to light leakage along the diagonal direction.

FIG. 2 is a Poincare sphere showing polarization states of light passing through an IPS mode LCD device of FIG. 1 along a front direction, and FIG. 3 is a Poincare sphere showing polarization states of light passing through an IPS mode LCD device of FIG. 1 along a diagonal direction. In FIGS. 2 and 3, points A and A′ represent transmission and absorption axes, respectively, of the upper polarizing plates 18a, and points B and B′ represent transmission and absorption axes, respectively, of the lower polarizing plate 18b.

In FIG. 2, the front direction has a polar angle θ of about 0° and an azimuthal angle φ of about 0°. In addition, the transmission axis A of the upper polarizing plate 18a and the absorption axis B′ of the lower polarizing plate 18b have the same position as each other, and the absorption axis A′ of the upper polarizing plate 18a and the transmission axis B of the lower polarizing plate 18b have the same position as each other. Accordingly, the transmission axis A of the upper polarizing plate 18a is perpendicular to the transmission axis B of the lower polarizing plate 18b, and the absorption axis A′ of the upper polarizing plate 18a is perpendicular to the absorption axis B′ of the lower polarizing plate 18b.

When the IPS mode LCD device 10 is viewed along the front direction, since the absorption axis A′ of the upper polarizing plate 18a is disposed at the same position as the transmission axis B of the lower polarizing plate 18b, the light passing through the lower polarizing plate 18b is completely absorbed by the upper polarizing plate 18a and a light leakage is prevented. As a result, a perfect black state is obtained.

In FIG. 3, the diagonal direction has a polar angle θ of about 60° and an azimuthal angle φ of about 45°. In addition, the transmission axis A of the upper polarizing plate 18a and the absorption axis B′ of the lower polarizing plate 18b have different positions from each other to make a predetermined angle, and the absorption axis A′ of the upper polarizing plate 18a and the transmission axis B of the lower polarizing plate 18b have different positions from each other to make a predetermined angle.

When the IPS mode LCD device 10 is viewed along the diagonal direction, since the absorption axis A′ of the upper polarizing plate 18a is disposed at the position different from the transmission axis B of the lower polarizing plate 18b, the light passing through the lower polarizing plate 18b is not completely absorbed by the upper polarizing plate 18a and a light leakage occurs. As a result, an imperfect black state is obtained.

FIG. 4 is a view showing a contrast ratio of an IPS mode LCD device according to the related art in a black state. In FIG. 4, a light leakage occurs at azimuthal angles φ of about 45°, about 135°, about 225° and about 315°, which correspond to a diagonal direction, of the IPS mode LCD device in a black state, and the brightness of the IPS mode LCD device is increased. Accordingly, a contrast ratio of the IPS mode LCD device is reduced.

### SUMMARY OF THE INVENTION

Accordingly, the present invention is directed to a liquid crystal display device that substantially obviates one or more of the problems due to limitations and disadvantages of the related art.

An advantage of the present invention is to provide a liquid crystal display device where a light leakage is prevented in a black state by using a first polarizing layer including an E-type polarizer and a second polarizing layer including an O-type polarizer.

Another advantage of the present invention is to provide a liquid crystal display device where a light leakage is prevented and a contrast ratio along a front direction is improved by using a first polarizing layer including an E-type polarizer, a second polarizing layer including an O-type polarizer and a third polarizing layer including O-type polarizer.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal display device includes: upper and lower substrates facing and spaced apart from each other; a liquid crystal layer between the upper and lower substrates; an upper polarizing plate on an outer surface of the upper substrate; and a lower polarizing plate on an outer surface of the lower substrate, wherein one of the upper and lower polarizing plates includes a first polarizing layer having a first optical axis and a first absorption axis perpendicular to each other, and an other of the upper and lower polarizing plates includes a second polarizing layer having a second optical axis and a second absorption axis parallel to each other.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view showing an IPS mode LCD device according to the related art;

FIG. 2 is a Poincare sphere showing polarization states of light passing through an IPS mode LCD device of FIG. 1 along a front direction;

FIG. 3 is a Poincare sphere showing polarization states of light passing through an IPS mode LCD device of FIG. 1 along a diagonal direction;

FIG. 4 is a view showing a contrast ratio of an IPS mode LCD device according to the related art in a black state;

FIG. 5 is a cross-sectional view showing an IPS mode LCD device according to a first embodiment of the present invention;

FIG. 6 is a view showing an E-type polarizer for an IPS mode LCD device according to a first embodiment of the present invention;

FIG. 7 is a view showing an O-type polarizer for an IPS mode LCD device according to a first embodiment of the present invention;

FIG. 8 is a Poincare sphere showing polarization states of light passing through an IPS mode LCD device according to a first embodiment of the present invention along a front direction;

FIG. 9 is a Poincare sphere showing polarization states of light passing through an IPS mode LCD device according to a first embodiment of the present invention along a diagonal direction;

FIG. 10 is a cross-sectional view showing an IPS mode LCD device according to a second embodiment of the present invention;

FIG. 11 is a graph showing a brightness of a white image along a front direction (front white) and a brightness of a black image along a diagonal direction (diagonal black) according to a dichroic ratio (Kd) of a second upper polarizing layer of an E-type polarizer of an IPS mode LCD device according to a second embodiment of the present invention;

FIGS. 12A and 12B are views showing a contrast ratio of an IPS mode LCD device according to a second embodiment of the present invention in a white state and in a black state, respectively;

FIG. 13 is a cross-sectional view showing an IPS mode LCD device according to a third embodiment of the present invention;

FIG. 14 is a graph showing a brightness of a white image along a front direction (front white) and a brightness of a black image along a diagonal direction (diagonal black) according to a dichroic ratio (Kd) of a first lower polarizing layer of an E-type polarizer of an IPS mode LCD device according to a third embodiment of the present invention; and

FIGS. 15A and 15B are views showing a contrast ratio of an IPS mode LCD device according to a third embodiment of the present invention in a white state and in a black state, respectively.

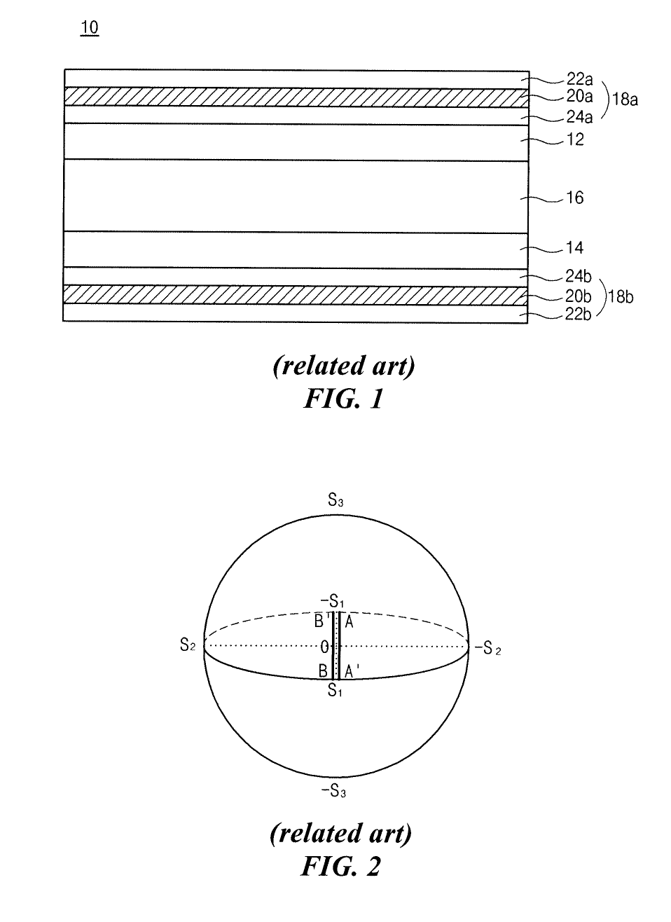

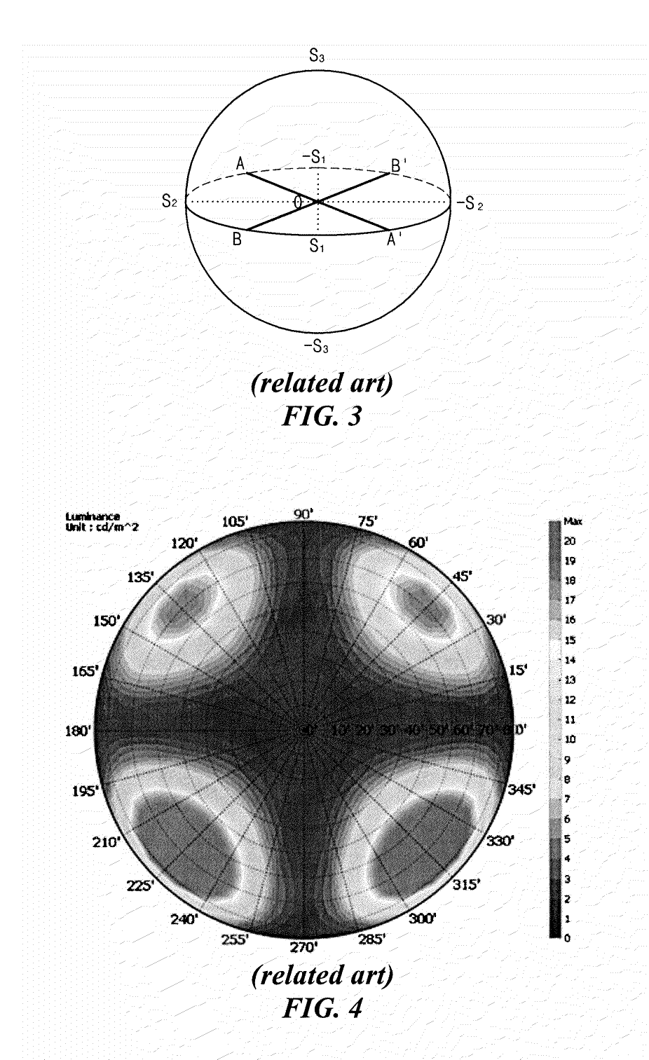

### DETAILED DESCRIPTION OF THE ILLUSTRATED EMBODIMENTS

Reference will now be made in detail to embodiments of the present invention, examples of which are illustrated in the accompanying drawings. Wherever possible, similar reference numbers will be used to refer to the same or similar parts.

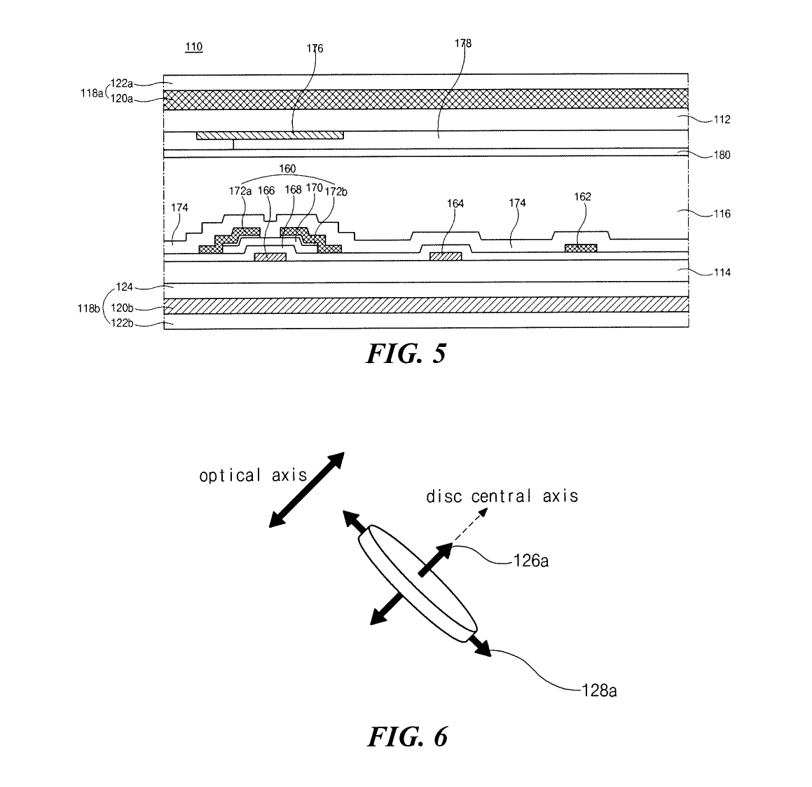

FIG. 5 is a cross-sectional view showing an IPS mode LCD device according to a first embodiment of the present invention.

In FIG. 5, an IPS mode LCD device 110 includes upper and lower substrates 112 and 114 facing and spaced apart from each other, a liquid crystal layer 116 between the upper and lower substrates 112 and 114, an upper polarizing plate 118a on an outer surface of the upper substrate 112 and a lower polarizing plate 118b on an outer surface of the lower substrate 114.

A thin film transistor (TFT) 160, a pixel electrode 162 connected to the TFT 160 and a common electrode 164 generating a horizontal electric field with the pixel electrode 162 are formed on an inner surface of the lower substrate 114. The TFT 160 includes a gate electrode 166 on the inner surface of the lower substrate 114, a gate insulating layer 168 on the gate electrode 166, a semiconductor layer 170 on the gate insulating layer 168 over the gate electrode 166, and source and drain electrode 172a and 172b on the semiconductor layer 170 and spaced apart from each other.

The common electrode 164 may be formed simultaneously with the gate electrode 166, and the gate insulating layer 168 may be formed between the common electrode 164 and the pixel electrode 162. In another embodiment, the common electrode 164 and the pixel electrode 162 may include the same layer as each other. The common electrode 164 and the pixel electrode 162 are spaced apart from each other, and generate the horizontal electric field by an applied voltage. A passivation layer 174 is formed on the TFT 160, the pixel electrode 162 and the gate insulating layer 168.

A black matrix 176 having an open portion is formed on an inner surface of the upper substrate 112, and a color filter layer 178 is formed on the color filter layer 176. The black matrix 176 blocks a light from a portion outside of a pixel region including the pixel electrode 162. An overcoat layer 180 is formed on the color filter layer 178. The overcoat layer 180 protects the color filter layer 178 and prevents eruption from the color filter layer 178.

The upper polarizing plate 118a includes an upper polarizing layer 120a on the outer surface of the upper substrate 112 and a first outer supporting layer 122a on the upper polarizing layer 120a. The lower polarizing plate 118b includes an inner supporting layer 124 on the outer surface of the lower substrate 114, the lower polarizing layer 120b on the inner supporting layer 124 and a second outer supporting layer 122b on the lower polarizing layer 120b. The upper and lower polarizing layers 120a and 120b include an E-type polarizer and an O-type polarizer, respectively.

The upper and lower polarizing layers 120a and 120b have first and second transmission axes (i.e., first and second polarization axes), respectively, perpendicular to each other. In addition, a first optical axis of the upper polarizing layer 120a, a second optical axis of the lower polarizing layer 120b and a third optical axis of the liquid crystal layer 116 are parallel to one another.

The first and second outer supporting layers 122a and 122b and the inner supporting layer 124 may be used for protecting the upper and lower polarizing layers 120a and 120b and may have a film type. The first and second outer supporting layers 122a and 122b protecting outer surfaces of the upper and lower polarizing layers 120a and 120b may have a thin film of tri acetyl cellulose (TAC), and the inner supporting layer 124 protecting an inner surface of the lower polarizing layer 120b may have a thin film of tri acetyl cellulose (TAC) having no phase difference (zero retardation). Since the E-type polarizer can be used as a film type without a supporting layer, an additional supporting layer between the upper polarizing layer 120a of the E-type polarizer and the upper substrate 112 may be omitted.

The E-type polarizer for the upper polarizing layer 120a and the O-type polarizing layer for the lower polarizing layer 120b will be illustrated hereinafter.

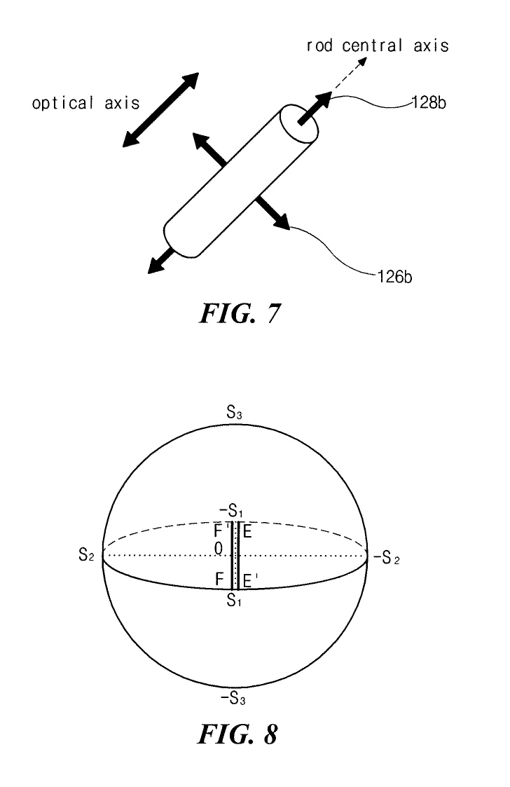

FIGS. 6 and 7 are views showing an E-type polarizer and an O-type polarizer, respectively, for an IPS mode LCD device according to a first embodiment of the present invention.

In FIG. 6, an E-type polarizer may have a disc shape having a disc central axis and may include a single supramolecular complex or several organic compounds. The E-type polarizer has an optical axis parallel to the disc central axis, a first transmission axis (i.e., a first polarization axis) 126a parallel to the disc central axis and a first absorption axis 128a perpendicular to the disc central axis.

In FIG. 7, an O-type polarizer may have a rod shape having a rod central axis and may include a poly vinyl alcohol (PVA) resin dyed with iodine where iodine is arranged along a stretching direction. The O-type polarizer has an optical axis parallel to the disc central axis, a second transmission axis (i.e., a second polarization axis) 126b perpendicular to the rod central axis and a second absorption axis 128b parallel to the rod central axis.

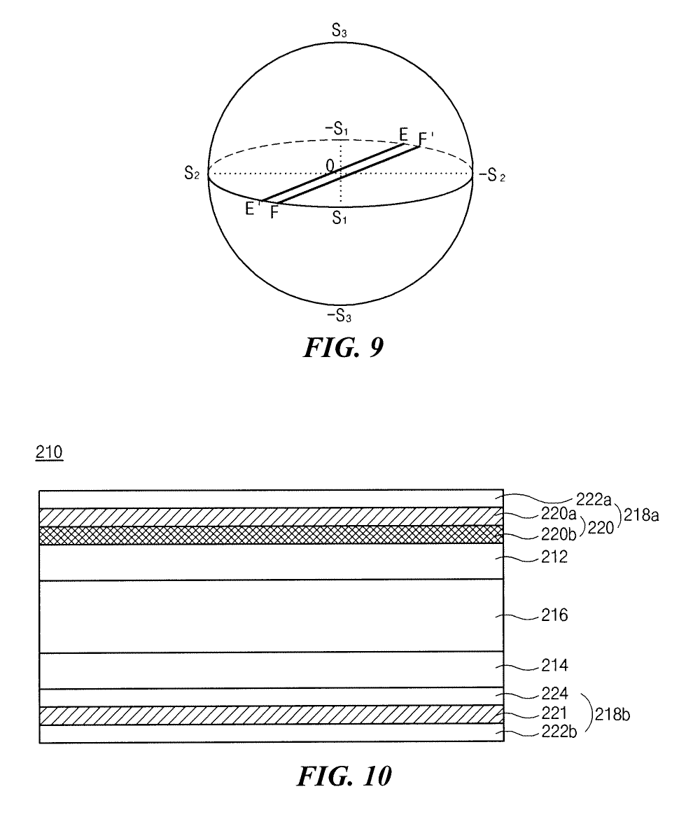

FIG. 8 is a Poincare sphere showing polarization states of light passing through an IPS mode LCD device according to a first embodiment of the present invention along a front direction, and FIG. 9 is a Poincare sphere showing polarization states of light passing through an IPS mode LCD device according to a first embodiment of the present invention along a diagonal direction.

In FIGS. 8 and 9, points E and E′ represent transmission and absorption axes, respectively, of the upper polarizing plates 118a, and points F and F′ represent transmission and absorption axes, respectively, of the lower polarizing plate 118b. The Poincare sphere represents polarization states of light on a spherical surface. The Poincare sphere is widely used for designing compensation films because polarization states are easily predicted by using the Poincare sphere if optical axes and phase retardation values of the optical elements are known. In the Poincare sphere, the equator designates the linear polarization, the north polar point S3 designates the left handed circular polarization, the south polar point −S3 designates the right handed circular polarization, the upper hemisphere designates the left handed elliptical polarization, and the lower hemisphere designates right handed elliptical polarization.

In FIG. 8, the front direction has a polar angle θ of about 0° and an azimuthal angle φ of about 0°. In addition, the transmission axis E of the upper polarizing plate 118a and the absorption axis F′ of the lower polarizing plate 118b have the same position (−S1) as each other, and the absorption axis E′ of the upper polarizing plate 118a and the transmission axis F of the lower polarizing plate 118b have the same position (S1) as each other. Accordingly, the transmission axis E of the upper polarizing plate 118a is perpendicular to the transmission axis F of the lower polarizing plate 118b, and the absorption axis E′ of the upper polarizing plate 118a is perpendicular to the absorption axis F′ of the lower polarizing plate 118b.

When the IPS mode LCD device 110 of FIG. 5 is viewed along the front direction, since the absorption axis E′ of the upper polarizing plate 118a is disposed at the same position (51) as the transmission axis F of the lower polarizing plate 118b, the light passing through the lower polarizing plate 118b is completely absorbed by the upper polarizing plate 118a and a light leakage is prevented. As a result, a perfect black state is obtained.

In FIG. 9, the diagonal direction has a polar angle θ of about 60° and an azimuthal angle φ of about 45°. In addition, the transmission axis E of the upper polarizing plate 118a and the absorption axis F′ of the lower polarizing plate 118b have the same position as each other, and the absorption axis E′ of the upper polarizing plate 118a and the transmission axis F of the lower polarizing plate 118b have the same position as each other. Accordingly, the transmission axis E of the upper polarizing plate 118a is perpendicular to the transmission axis F of the lower polarizing plate 118b, and the absorption axis E′ of the upper polarizing plate 118a is perpendicular to the absorption axis F′ of the lower polarizing plate 118b.

When the IPS mode LCD device 110 of FIG. 5 is viewed along the diagonal direction, since the absorption axis E′ of the upper polarizing plate 118a is disposed at the same position as the transmission axis F of the lower polarizing plate 118b, the light passing through the lower polarizing plate 118b is completely absorbed by the upper polarizing plate 118a and a light leakage is prevented. As a result, a perfect black state is obtained.

However, since the E-type polarizer has a relatively low absorption coefficient, the IPS mode LCD device 110 may have a disadvantage in a contrast ratio at a front direction. In a second embodiment, the contrast ratio at the front direction of the IPS mode LCD device is improved with preventing the light leakage.

FIG. 10 is a cross-sectional view showing an IPS mode LCD device according to a second embodiment of the present invention.

In FIG. 10, an IPS mode LCD device 210 includes upper and lower substrates 212 and 214 facing and spaced apart from each other, a liquid crystal layer 216 between the upper and lower substrates 212 and 214, an upper polarizing plate 218a on an outer surface of the upper substrate 212 and a lower polarizing plate 218b on an outer surface of the lower substrate 214.

Although not shown in FIG. 10, a thin film transistor (TFT), a pixel electrode connected to the TFT, a common electrode generating a horizontal electric field with the pixel electrode and a passivation layer may be formed on an inner surface of the lower substrate 214. In addition, a black matrix having an open portion, a color filter layer and an overcoat layer may be formed on an inner surface of the upper substrate 212.

The upper polarizing plate 218a includes an upper polarizing layer 220 on the outer surface of the upper substrate 212 and a first outer supporting layer 222a on the upper polarizing layer 220. The upper polarizing layer 220 includes a first upper polarizing layer 220a under the first outer supporting layer 222a and a second upper polarizing layer 220b between the first upper polarizing layer 220a and the upper substrate 212. The lower polarizing plate 218b includes an inner supporting layer 224 on the outer surface of the lower substrate 214, a lower polarizing layer 221 on the inner supporting layer 224 and a second outer supporting layer 222b on the lower polarizing layer 221. Each of the first upper polarizing layer 220a and the lower polarizing layer 221 includes an O-type polarizer, and the second upper polarizing layer 220b includes an E-type polarizer.

The first and second upper polarizing layers 220a and 220b have first and second transmission axes (i.e., first and second polarization axes), respectively, perpendicular to each other. In addition, the lower polarizing layer 221 has a third transmission axis (i.e., a third polarization axis) perpendicular to the second polarization axis. Further, a first optical axis of the first upper polarizing layer 220a is perpendicular to each of a second optical axis of the second upper polarizing layer 220b, a third optical axis of the lower polarizing layer 221 and a fourth optical axis of the liquid crystal layer 216 which are parallel to one another.

The first and second outer supporting layers 222a and 222b and the inner supporting layer 224 may be used for protecting the upper and lower polarizing layers 220 and 221 and may have a film type. The first and second outer supporting layers 222a and 222b protecting outer surfaces of the upper and lower polarizing layers 220 and 221 may have a thin film of tri acetyl cellulose (TAC), and the inner supporting layer 224 protecting an inner surface of the lower polarizing layer 221 may have a thin film of tri acetyl cellulose (TAC) having no phase difference (zero retardation). Since the E-type polarizer can be used as a film type without a supporting layer, an additional supporting layer between the second upper polarizing layer 220b of the E-type polarizer and the upper substrate 212 may be omitted.

In the IPS mode LCD device 210, the second upper polarizing layer 220b of the E-type polarizer is disposed under the first upper polarizing layer 220a of the O-type polarizer, and the lower polarizing layer 221 of the O-type polarizer is disposed to have an O-mode where the third optical axis of the lower polarizing layer 221 is parallel to the fourth optical axis of the liquid crystal layer 216.

Since a light from a backlight unit (not shown) passes through the lower polarizing layer 221 and the second upper polarizing layer 220b, the light leakage along the diagonal direction is minimized. In addition, since the light from the second upper polarizing layer 220b passes through the first upper polarizing layer 220a, the contrast ratio along the front direction is improved.

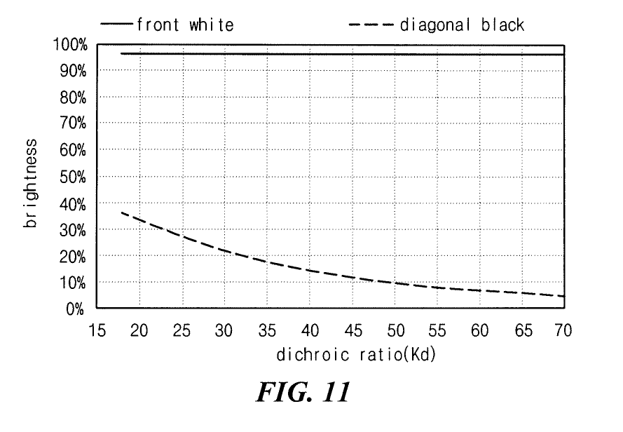

TABLE 1 and FIG. 11 are a table and a graph, respectively, showing a brightness of a white image along a front direction (front white) and a brightness of a black image along a diagonal direction (diagonal black) according to a dichroic ratio (Kd) of a second upper polarizing layer of an E-type polarizer of an IPS mode LCD device according to a second embodiment of the present invention.

TABLE 1

| dichroic ratio | brightness of | brightness of |
|---|---|---|
| (Kd) | front white (%) | diagonal black (%) |
| 18 | 96.3 | 36.0 |
| 20 | 96.4 | 33.1 |
| 25 | 96.4 | 26.8 |
| 30 | 96.4 | 21.7 |
| 35 | 96.4 | 17.6 |
| 40 | 96.4 | 14.3 |
| 45 | 96.4 | 11.6 |
| 50 | 96.4 | 9.4 |
| 55 | 96.4 | 7.8 |
| 60 | 96.4 | 6.4 |
| 65 | 96.3 | 5.4 |
| 70 | 96.3 | 4.5 |

In TABLE 1 and FIG. 11, the dichroic ratio is obtained from the second upper polarizing layer 220b of the E-type polarizer having a thickness such that the brightness of front white decreases by about 3% of the maximum value, and the diagonal direction has a polar angle θ of about 60° and an azimuthal angle φ of about 45°.

In TABLE 1 and FIG. 11, as the dichroic ratio increases, the light leakage along the diagonal direction is reduced. Since the brightness of diagonal black of about 20% is admitted in the IPS mode LCD device, the light leakage is minimized with an optimum brightness of front white when the dichroic ratio is within a range of about 30 to about 70.

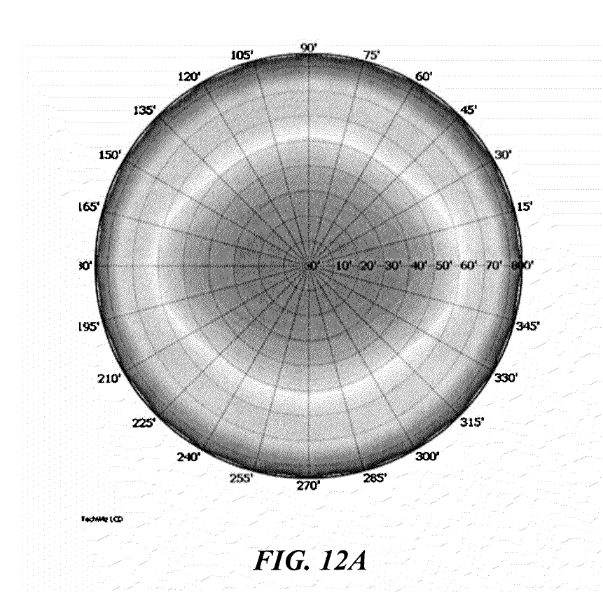

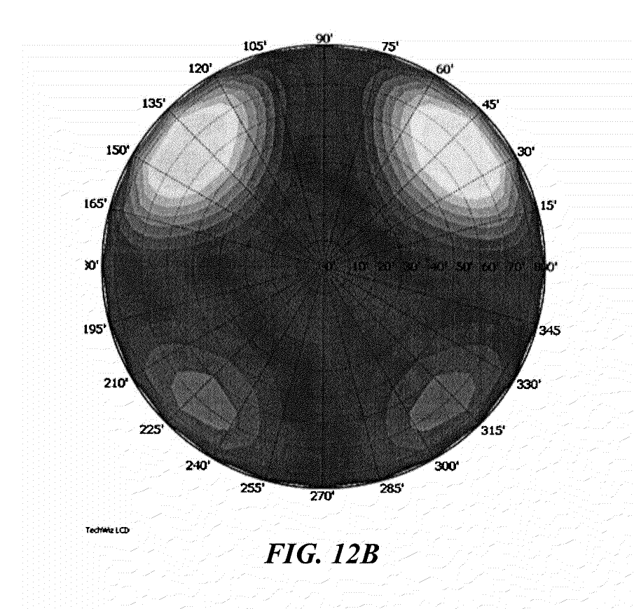

FIGS. 12A and 12B are views showing a contrast ratio of an IPS mode LCD device according to a second embodiment of the present invention in a white state and in a black state, respectively.

As shown in FIG. 12A, the IPS mode LCD device 210 has the brightness of front white similar to an IPS mode LCD device according to the related art. Further, as shown in FIG. 12B, the brightness of diagonal black of the IPS mode LCD device 210 is improved as compared with an IPS mode LCD device according to the related art.

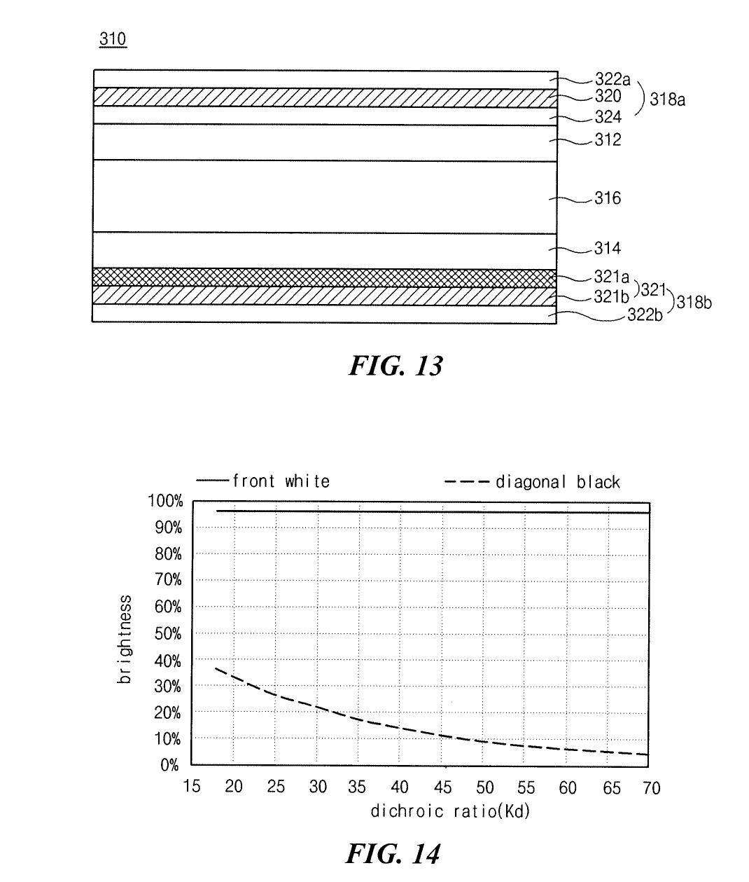

FIG. 13 is a cross-sectional view showing an IPS mode LCD device according to a third embodiment of the present invention.

In FIG. 13, an IPS mode LCD device 310 includes upper and lower substrates 312 and 314 facing and spaced apart from each other, a liquid crystal layer 316 between the upper and lower substrates 312 and 314, an upper polarizing plate 318a on an outer surface of the upper substrate 312 and a lower polarizing plate 318b on an outer surface of the lower substrate 314.

Although not shown in FIG. 13, a thin film transistor (TFT), a pixel electrode connected to the TFT, a common electrode generating a horizontal electric field with the pixel electrode and a passivation layer may be formed on an inner surface of the lower substrate 314. In addition, a black matrix having an open portion, a color filter layer and an overcoat layer may be formed on an inner surface of the upper substrate 312.

The upper polarizing plate 318a includes an inner supporting layer 324 on the outer surface of the upper substrate 312, an upper polarizing layer 320 and a first outer supporting layer 322a on the upper polarizing layer 320. The lower polarizing plate 318b includes a lower polarizing layer 321 on the outer surface of the lower substrate 314 and a second outer supporting layer 322b on the lower polarizing layer 321. The lower polarizing layer 321 includes a first lower polarizing layer 321a under the lower substrate 314 and a second lower polarizing layer 321b under the first lower polarizing layer 321. Each of the upper polarizing layer 320 and the second lower polarizing layer 321b includes an O-type polarizer, and the first lower polarizing layer 321a includes an E-type polarizer.

The upper polarizing layer 320 has a first transmission axis (i.e., a first polarization axis). In addition, the first and second lower polarizing layer 321a and 321b have second and third transmission axes (i.e., second and third polarization axes), respectively, perpendicular to each other. The first transmission axis is perpendicular to the second transmission axis. Further, a third optical axis of the second lower polarizing layer 321b is perpendicular to each of a first optical axis of the upper polarizing layer 320, a second optical axis of the first lower polarizing layer 321a and a fourth optical axis of the liquid crystal layer 316 which are parallel to one another.

The first and second outer supporting layers 322a and 322b and the inner supporting layer 324 may be used for protecting the upper and lower polarizing layers 320 and 321 and may have a film type. The first and second outer supporting layers 322a and 322b protecting outer surfaces of the upper and lower polarizing layers 320 and 321 may have a thin film of tri acetyl cellulose (TAC), and the inner supporting layer 324 protecting an inner surface of the upper polarizing layer 320 may have a thin film of tri acetyl cellulose (TAC) having no phase difference (zero retardation). Since the E-type polarizer can be used as a film type without a supporting layer, an additional supporting layer between the second lower polarizing layer 321b of the E-type polarizer and the lower substrate 314 may be omitted.

In the IPS mode LCD device 310, the first lower polarizing layer 321a of the E-type polarizer is disposed on the second lower polarizing layer 321b of the O-type polarizer, and the lower polarizing layer 321 is disposed to have an E-mode where the third optical axis of the second lower polarizing layer 321b of the O-type polarizer is perpendicular to the fourth optical axis of the liquid crystal layer 316.

Since a light from a backlight unit (not shown) passes through the first and second lower polarizing layers 321a and 321b, the light leakage along the diagonal direction is minimized. In addition, since the light from the first lower polarizing layer 321a passes through the upper polarizing layer 320, the contrast ratio along the front direction is improved.

TABLE 2 and FIG. 14 are a table and a graph, respectively, showing a brightness of a white image along a front direction (front white) and a brightness of a black image along a diagonal direction (diagonal black) according to a dichroic ratio (Kd) of a first lower polarizing layer of an E-type polarizer of an IPS mode LCD device according to a third embodiment of the present invention.

TABLE 2

| dichroic ratio | brightness of | brightness of |
|---|---|---|
| (Kd) | front white (%) | diagonal black (%) |
| 18 | 96.3 | 36.2 |
| 20 | 96.3 | 33.3 |
| 25 | 96.3 | 26.9 |
| 30 | 96.3 | 21.8 |
| 35 | 96.3 | 17.7 |
| 40 | 96.3 | 14.4 |
| 45 | 96.3 | 11.7 |
| 50 | 96.3 | 9.5 |
| 55 | 96.3 | 7.9 |
| 60 | 96.3 | 6.5 |
| 65 | 96.3 | 5.4 |
| 70 | 96.3 | 4.6 |

In TABLE 2 and FIG. 14, the dichroic ratio is obtained from the first lower polarizing layer 321a of the E-type polarizer having a thickness such that the brightness of front white decreases by about 3% of the maximum value, and the diagonal direction has a polar angle θ of about 60° and an azimuthal angle φ of about 45°.

In TABLE 1 and FIG. 11, as the dichroic ratio increases, the light leakage along the diagonal direction is reduced. Since the brightness of diagonal black of about 20% is admitted in the IPS mode LCD device, the light leakage is minimized with an optimum brightness of front white when the dichroic ratio is within a range of about 30 to about 70.

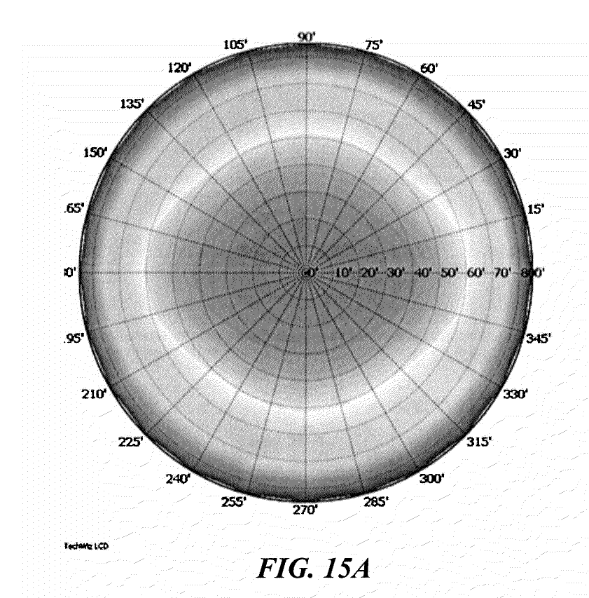

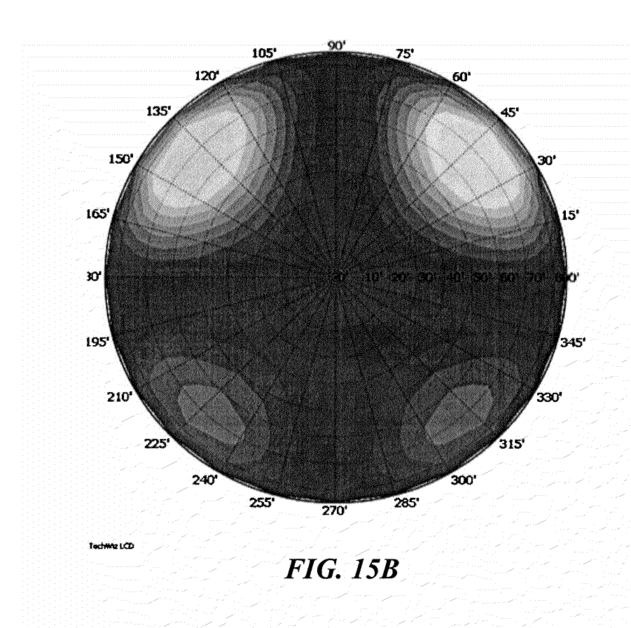

FIGS. 15A and 15B are views showing a contrast ratio of an IPS mode LCD device according to a third embodiment of the present invention in a white state and in a black state, respectively.

As shown in FIG. 15A, the IPS mode LCD device 310 has the brightness of front white similar to an IPS mode LCD device according to the related art. Further, as shown in FIG. 15B, the brightness of diagonal black of the IPS mode LCD device 310 is improved as compared with an IPS mode LCD device according to the related art.

As in the second and third embodiments, the light leakage along the diagonal direction is minimized and the contrast ratio along the front direction is improved by forming an E-type polarizer and an O-type polarizer one of the first and second substrates and forming an O-type polarizer on the other one of the first and second substrates. The E-type polarizer contacts the one of the first and second substrates, and the O-type polarizer is formed on the E-type polarizer.

Consequently, in the IPS mode LCD device according to the present invention, since the transmission axis (polarization axis) of the E-type polarizer and the transmission axis (polarization axis) of the O-type polarizer are perpendicular to each other along the front diagonal directions, the light leakage along the front and diagonal directions is minimized and color inversion according to the viewing angle is improved. In addition, the contrast ratio along the front direction is improved by using an additional O-type polarizer.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
upper and lower substrates facing and spaced apart from each other;
a liquid crystal layer between the upper and lower substrates;
an upper polarizing plate on an outer surface of the upper substrate; and
a lower polarizing plate on an outer surface of the lower substrate,
wherein one of the upper and lower polarizing plates includes a first polarizing layer having a first optical axis and a first absorption axis perpendicular to each other, and an other of the upper and lower polarizing plates includes a second polarizing layer having a second optical axis and a second absorption axis parallel to each other.

2. The device according to claim 1, wherein the first and second polarizing layers have first and second transmission axes, respectively, perpendicular to each other.

3. The device according to claim 1, wherein the liquid crystal layer has a third optical axis, and the first, second and third optical axes are parallel to one another.

4. The device according to claim 1, wherein the upper polarizing plate includes the first polarizing layer on the outer surface of the upper substrate and a first outer supporting layer on the first polarizing layer, and the lower polarizing plate includes an inner supporting layer on the outer surface of the lower substrate, the second polarizing layer on the inner supporting layer and a second outer supporting layer on the second polarizing layer.

5. The device according to claim 4, wherein each of the first and second outer supporting layers includes a thin film of tri acetyl cellulose (TAC), and the inner supporting layer angle includes a thin film of tri acetyl cellulose (TAC) having no phase difference.

6. The device according to claim 4, wherein the upper polarizing plate further includes a third polarizing layer having a third optical axis and a third absorption axis parallel to each other between the first polarizing layer and the first outer supporting layer.

7. The device according to claim 6, wherein the liquid crystal layer has a fourth optical axis parallel to the second optical axis.

8. The device according to claim 7, wherein the first, second and fourth optical axes are parallel to each other, and the third optical axis is perpendicular to each of the first, second and fourth optical axes.

9. The device according to claim 1, wherein the upper polarizing plate includes an inner supporting layer on the outer surface of the upper substrate, the second polarizing layer on the inner supporting layer and a first outer supporting layer on the second polarizing layer, and the lower polarizing plate includes the first polarizing layer on the outer surface of the lower substrate and a second outer supporting layer on the first polarizing layer.

10. The device according to claim 9, wherein the lower polarizing plate further includes a third polarizing layer having a third optical axis and a third absorption axis parallel to each other between the first polarizing layer and the second outer supporting layer.

11. The device according to claim 9, wherein the liquid crystal layer has a fourth optical axis perpendicular to the third optical axis.

12. The device according to claim 11, wherein the first, second and fourth optical axes are parallel to each other, and the third optical axis is perpendicular to each of the first, second and fourth optical axes.

13. The device according to claim 1, wherein the first polarizing layer includes E-type polarizer, and the second polarizing layer includes O-type polarizer.
